(19) United States
(12) Patent Application Publication
(10) Pub. No.: US 2024/0384672 A1
(43) Pub. Date: Nov. 21, 2024

(54) METHOD FOR DIAGNOSING A CRANKCASE SYSTEM, CRANKCASE SYSTEM, VEHICLE AND COMPUTER PROGRAM PRODUCT

(71) Applicant: Volkswagen Aktiengesellschaft, Wolfsburg (DE)

(72) Inventors: Mathias HAUPTVOGEL, Weferlingen (DE); Stephan WASSMANN, Isenbuettel (DE); Fabian Berski, Hannover (DE)

(73) Assignee: Volkswagen Aktiengesellschaft, Wolfsburg (DE)

(21) Appl. No.: 18/667,747

(22) Filed: May 17, 2024

(30) Foreign Application Priority Data
May 17, 2023 (DE) 10 2023 204 666.0

(51) Int. Cl. F01M 11/10; G07C 5/08

(52) U.S. Cl. CPC F01M 11/10; G07C 5/0808

(57) ABSTRACT

A method for diagnosing a crankcase system, comprising a determination of a signal waveform of an intake pressure in an intake area of a crankcase, a determination of a signal waveform of a second pressure in an area of the crankcase downstream of the intake area, a calculation of a similarity between the signal waveform of the intake pressure and the signal waveform of the second pressure, and a comparison of similarity with a similarity setpoint range. A deviation of similarity from the similarity setpoint range indicates an improper condition of the crankcase system. Furthermore, a crankcase system, a vehicle and a computer program product are provided.

This nonprovisional application claims priority under 35 U.S.C. § 119(a) to German Patent Application No. 10 2023 204 666.0, which was filed in Germany on May 17, 2023, and which is herein incorporated by reference.

### BACKGROUND OF THE INVENTION

### Field of the Invention

The present invention relates to a method for diagnosing a crankcase system, a crankcase system, a vehicle, and a computer program product.

### Description of the Background Art

A crankcase is a device that essentially serves as a bearing for the crankshaft in internal combustion engines. The crankcase can also include the cylinders, the cooling jacket and the engine casing of an internal combustion engine.

In a crankcase, there are always certain pressure fluctuations during the operation of the combustion engine.

Gases that flow past the cylinder during combustion are fed back into the intake tract of the combustion engine in so-called closed crankcase ventilation systems or positive crankcase ventilation (PCV) systems.

For the operation of the engine, it is particularly important that the crankcase system is intact, otherwise the service life of the internal combustion engine or its components can be significantly reduced.

Various diagnostic systems for crankcases are known from the conventional art, for example from DE 10 2015 116 483 A1 (which corresponds to US 2016/0097355) and DE 10 2021 124 041 A1 (which corresponds to U.S. Pat. No. 11,220,939).

However, there is still a need to provide particularly reliable, accurate and cost-effective diagnostics of the crankcase.

### SUMMARY OF THE INVENTION

It is therefore an object of the present invention to at least partially remedy the above disadvantages known from the prior art. In particular, one of the objects of the present invention is to provide a method for diagnosing a crankcase system, a crankcase system, a vehicle and a computer program product which enable reliable, accurate and inexpensive diagnostics of the crankcase.

The preceding object is achieved by a method, a crankcase system, a vehicle, and a computer program product. Features and details that are described in connection with the method according to the invention naturally also apply in connection with the crankcase system according to the invention, the vehicle according to the invention and/or the computer program product according to the invention, and vice versa in each case, so that with regard to the disclosure to the individual aspects of the invention there is or can always be reciprocal reference.

According to a first aspect of the invention, a method for diagnosing a crankcase system is provided, comprising: determination of a signal waveform of an intake pressure in an intake area of a crankcase, in particular by means of an intake pressure sensor, determination of a signal waveform of a second pressure in an area of the crankcase downstream of the intake area, in particular by means of a second pressure sensor; calculation of similarity between the signal waveform of the intake pressure and the signal waveform of the second pressure, in particular by a processor, and comparison of similarity to a similarity setpoint range, in particular by the processor. A deviation of similarity from the similarity setpoint range indicates an improper condition of the crankcase system.

In particular, the method may be a computer-implemented method.

The method steps may take place, at least partially, simultaneously and/or sequentially, wherein the sequence of the method steps is not limited by the specified order, so that individual steps can be carried out in different order. In addition, some or all of the steps can be performed repeatedly.

A crankcase, also known as an engine casing or engine block, can be thought of as an assembly containing at least one cylinder, a cylinder cooling jacket, a crankshaft, a crankshaft bearing or an oil pan.

In other words, a method may be provided for determining the condition of a crankcase system by recording at least two pressures in different areas of the crankcase system and comparing their measured curves to see whether they show similar changes. At least some pressure is absorbed in an area of the crankcase which is designed to supply a fluid, in particular air and/or an air mixture, to the crankcase, in particular a combustion chamber of the internal combustion engine. In particular, a fluid may include fuel and/or products of the combustion process of the internal combustion engine that are not completely combusted. Further pressure is absorbed in an area of the crankcase located downstream of the first area. If the two pressures show very different curves, this may mean that the crankcase system is at least in an improper condition, in particular has a leak or blockage. In a proper condition, the pressure conditions in the crankcase remain within a certain range in relation to a surrounding atmosphere, and leakage gases (also known as “blowby” gases) produced in the engine are collected and discharged in an environmentally friendly manner as designed. In other words, any condition that deviates from the proper condition may correspond to an improper condition.

In the context of the invention, a diagnosis can be understood as a process of assessing the condition of a system. In particular, the diagnosis may include determining whether a defect is present or not. Furthermore, the diagnosis can also include a graded statement about the status of the system. It may be provided that the diagnosis includes an indication of the tightness, in particular in percentage, with 100% preferably corresponding to a system that is tight as intended and 0% to a defective system. The advantage of comprehensive diagnostics is that they can be used during the maintenance of the crankcase, so that maintenance can be simplified and costs can be saved.

Determining a signal waveform can be understood as the recording of at least two, in particular a plurality of measured values. The determination of the signal waveform can be understood as a measurement of at least one variable that changes over time.

The intake pressure can be understood as the pressure that prevails at a position in the intake area of the crankcase. The aspirated fluid can be made available to an internal combustion engine for combustion in one or more combustion chambers.

The features described in connection with the method according to the invention, which refer to a crankcase system to be diagnosed, also refer to a crankcase system according to the invention, which is described in more detail later.

The intake area of the crankcase can be understood as an assembly designed to provide the crankcase, in particular the crankcase block, with a fluid, in particular air and/or an air mixture. The intake area can include at least one intake manifold. At least one throttle can be located in the intake manifold.

The crankcase may have a crankcase block in which a cylinder and a crankshaft can be arranged. Furthermore, the crankcase may have an oil pan. Furthermore, the crankcase includes both the intake area and the downstream area of the intake area, which can be designed in particular as a bleed area.

The second pressure is detected in an area that differs in position from the intake area. It is provided that the second pressure is measured downstream of the intake area. Downstream refers to the direction of movement of the fluid within the crankcase system. Depending on the operating mode, the fluid can be guided in different flow paths.

It may be provided that the second pressure is designed as a bleed pressure. The bleed pressure can be understood as the pressure that prevails at a position in a bleed area of the crankcase.

The bleed area can be understood as an assembly designed to discharge a fluid, in particular air and/or an air mixture, from the crankcase, in particular from the crankcase block. It may be provided that the bleed area directs a fluid, in particular air and/or an air mixture, away from the crankcase towards the intake area of the crankcase, in particular to one or more combustion chambers.

The second pressure can be designed as pressure in a crankcase ventilation line and/or pressure in the crankcase block.

The crankcase system can be designed as a closed crankcase system. In other words, it may be provided that air and/or an air mixture from the bleed area is fed back into the intake area.

A similarity can be understood as a measure, especially mathematical, of the similarity of two signal waveforms. It may be provided that similarity is a measure of the change in the signal waveform as a function of time. The similarity would be high if both signal waveforms change on a similar time scale. It may be that the similarity of the signal waveforms is high if they change by a similarly high value over time, especially in absolute terms.

Calculating a similarity with a similarity setpoint range can be thought of as a method suitable for determining a quantitative value for the similarity of the signal waveforms. Variants of this method are described in connection with the subclaims.

A similarity setpoint range can be a range of values that is specific to the condition of the crankcase system. The similarity setpoint range can also be implemented as a threshold value. It may also be provided that at least two similarity setpoint ranges are provided, wherein a first similarity setpoint range corresponds to a crankcase system that is sealed as intended and a second similarity setpoint range to an operational crankcase system with a measurable malfunction.

It may also be provided that an action is triggered in the event of a deviation of the similarity from the similarity setpoint range. An action can be implemented as a signal, in particular at least acoustically or visually. In addition, the signal may be received by a central control unit of a vehicle comprising the crankcase system. It may also be provided that the action includes at least an entry of or an increase in a meter reading in an error memory. In the event of a fault, for example, the engine can be switched off or a user of the vehicle can be asked to park the vehicle immediately or visit a repair shop. As a result, the service life of the crankcase system can be improved. It may also be provided that in the event of a deviation in similarity from the similarity setpoint range, charging by the turbocharger is prevented. This avoids discharging exhaust gases into the environment in the event of a line failure. It may also be provided that the action includes at least a reduction in the speed of the vehicle, a torque, an output of the engine, a remaining driving time or a transmission of the detected improper condition to a collection point, in particular at least the vehicle manufacturer or a repair shop.

Overall, the inventive method for diagnosing a crankcase system has the advantage of enabling reliable, accurate and cost-effective diagnostics of the crankcase system. The determination of the signal waveforms of the intake pressure and the bleed pressure provides information about two areas of the crankcase, which can be detected independently of each other and thus even provide a certain amount of information redundancy on their own. Basically, with a properly sealed crankcase system, it can be assumed that the signal waveform of the intake pressure and the bleed pressure react similarly to changes in the system. In the event of a deviation of this similarity, which is determined according to the invention and compared to a similarity setpoint, it is possible that the crankcase system is in a condition that deviates from the proper condition, in particular has a leak or a blockage. The comparison therefore makes it possible for a malfunction to be detected reliably and easily. This can also extend the service life of the crankcase system.

Furthermore, in a method according to the invention, it may be advantageously provided that the calculation includes at least a calculation of a correlation or the calculation of a covariance between the signal waveform of the intake pressure and the signal waveform of the second pressure. Both correlation and covariance can be determined in a relatively simple manner, especially in near real time. This provides a particularly fast, reliable measure of the similarity of the signal waveforms.

Furthermore, in a method according to the invention, it is conceivable that the calculation includes at least a calculation of a linear function whose course essentially corresponds to the signal waveform of the intake pressure and the signal waveform of the second pressure or includes the performance of a regression analysis. The determination of a linear function offers the advantage that a similarity of the signal waveforms can be easily and quickly determined from the linear function. In a regression analysis, a variety of statistical methods can be selected to determine similarity. The advantage of the regression analysis is that a statistical method tailored to the specific application can be chosen, by which the best compromise between speed of execution and accuracy of analysis can be selected.

In the context of the invention it is also conceivable that the determination of the signal waveform of the intake pressure in the intake area is configured as a determination of the signal waveform of the intake pressure at least in an intake manifold downstream of a throttle or upstream of the throttle. By determining the intake pressure in the intake manifold downstream of a throttle, the advantage can be achieved that a reduced pressure as compared to the ambient pressure can be measured. In the case of a measurement upstream of the throttle body, either an ambient pressure or a pressure is applied, which is increased by an exhaust gas turbocharger as compared to the pressure downstream of the throttle. It may also be provided that the intake pressure is an average of measurements downstream of the throttle and upstream of the throttle. As a result, measurement errors of a single sensor can be mitigated. It may also be provided that a plausibility analysis is carried out on the basis of pressure measurements downstream of the throttle and upstream of the throttle. This has the advantage of being able to detect a defective sensor.

In the context of the invention, it is also conceivable that the determination of the signal waveform of the second pressure in the area downstream of the intake area is carried out as a determination of the signal waveform of the second pressure at least in a bleed line of the crankcase, in a crankcase block or in a ventilation line of the crankcase. Measuring the second pressure can be advantageous depending on the operating mode of the combustion engine. Furthermore, the combination of several measurements can be used to carry out a plausibility analysis in order to check the functionality of the pressure sensors. Average values can also be calculated to reduce the impact of individual outliers on the similarity calculation.

Preferably, in a method according to the invention, it can be provided that at least the calculation of similarity takes place if a calculation condition is fulfilled at least for the intake pressure or the second pressure, or if the signal waveform of at least the intake pressure or the second pressure includes only values for which a recording condition is fulfilled when recorded. In other words, the calculation and/or recording of the values can only be carried out if predetermined conditions are met, in particular during a boost pressure build-up, a boost pressure maintenance or a boost pressure reduction. The calculation condition and/or the recording condition may include, for example, that the internal combustion engine is in operation and/or that the intake pressure, in particular the boost pressure, is within a predetermined value range, in particular between 1100 hPa and 1500 hPa. In addition, it may be provided that the calculation condition and/or the recording condition is executed as a time delay, in particular after a boost pressure build-up. By providing calculation conditions and/or recording conditions, the advantage is that the diagnosis becomes particularly reliable, as outliers are pre-filtered and no measurements or evaluations take place at a time when a diagnosis is not possible or useful.

According to another aspect of the invention, a crankcase system is provided, comprising: an intake pressure sensor designed to determine a signal waveform of an intake pressure in an intake area of a crankcase, a second pressure sensor designed to determine a signal waveform of a second pressure in an area of the crankcase downstream of the intake area, and a processor designed to calculate a similarity between the signal waveform of the intake pressure and the signal waveform of the second pressure and to compare the similarity with a similarity setpoint range. A deviation of similarity from the similarity setpoint range indicates an improper condition of the crankcase system.

Furthermore, in a crankcase system according to the invention, it may advantageously be provided that the crankcase system is designed to carry out a method according to the invention.

Thus, a crankcase system according to the invention has the same advantages as have already been described in detail with reference to a method according to the invention.

According to another aspect of the invention, a vehicle is provided having at least a crankcase system according to the invention.

Thus, a vehicle according to the invention has the same advantages as have already been described in detail with reference to a method according to the invention and/or a crankcase system according to the invention.

According to another aspect of the invention, a computer program product is provided, comprising commands which, when the program is executed by a computer, in particular a processor of a crankcase system according to the invention, causes it to execute a method according to the invention.

Thus, a computer program product according to the invention has the same advantages as have already been described in detail with reference to a method according to the invention, a crankcase system according to the invention and/or a vehicle according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a method according to the invention,

FIG. 2 shows exemplary measured values, and

FIG. 3 shows an exemplary determination of correlation and covariance for different situations in the crankcase system, and

FIG. 4 shows a crankcase system according to and example of the invention.

### DETAILED DESCRIPTION

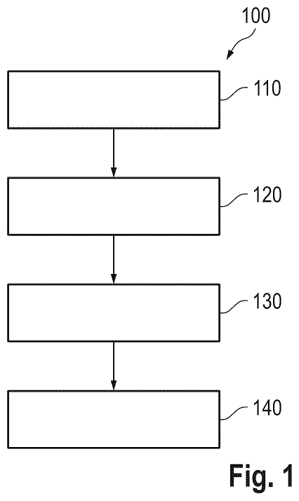

FIG. 1 schematically shows an inventive method 100 for diagnosing a crankcase system 200. The method 100 comprises a determination 110 of a signal waveform of an intake pressure 10 in an intake area 220 of a crankcase 210. In addition, the method 100 includes a determination 120 of a signal waveform of a second pressure 20 in an area 230 of the crankcase 210 downstream of the intake area. The method 100 also includes a calculation 130 of a similarity between the signal waveform of the intake pressure 10 and the signal waveform of the second pressure 20. Part of the method 100 is also a comparison 140 of similarity with a similarity setpoint range. A deviation in similarity from the similarity setpoint range indicates that the crankcase system 200 is in an improper condition.

Overall, the inventive method 100 for diagnosing a crankcase system 200 achieves the advantage of enabling reliable, accurate and cost-effective diagnostics of the crankcase system 200. The determination of the signal waveforms of the intake pressure 10 and the second pressure 20 provides information about two areas of the crankcase 210 that can be detected independently of each other and thus even provide a certain amount of information redundancy on their own. Basically, with a properly sealed crankcase system 200, it can be assumed that the signal waveform of the intake pressure 10 and the second pressure 20 react similarly to changes in the system. In the event of a deviation of this similarity, which is determined according to the invention and compared to a similarity setpoint, it is possible that the crankcase system 200 has a malfunction. The comparison therefore makes it possible for a malfunction to be detected reliably and easily. This can also extend the service life of the crankcase system 200.

Furthermore, in a method 100 according to the invention, it may be advantageously provided that the calculation 130 includes at least one calculation 130 of a correlation or the calculation 130 of a covariance between the signal waveform of the intake pressure 10 and the signal waveform of the second pressure 20. Both correlation and covariance can be determined in a relatively simple manner, especially in near real time. This provides a particularly fast, reliable measure of the similarity of the signal waveforms.

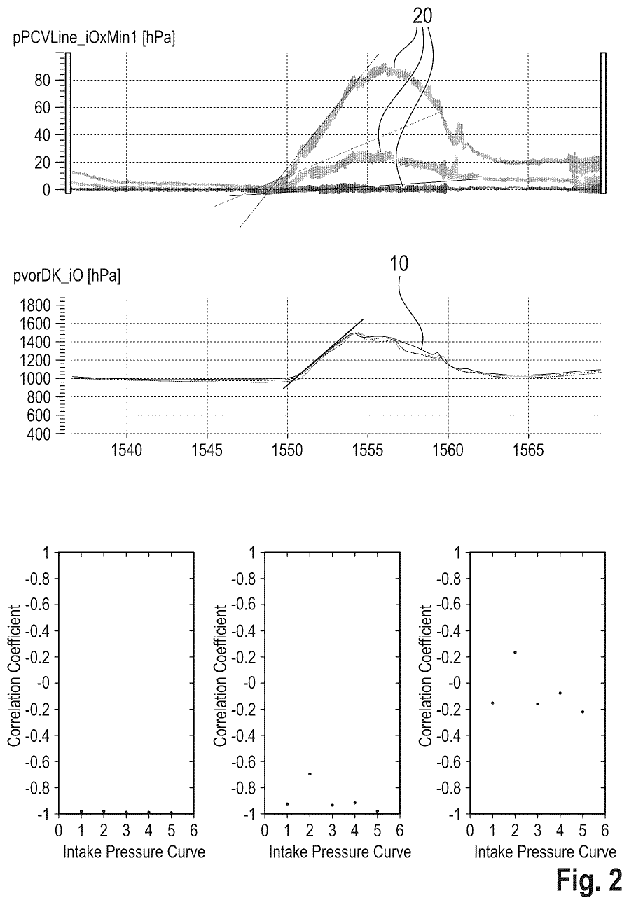

FIG. 2 shows an example of measured values for a second pressure 20 (top) and an intake pressure 10 (bottom) for different conditions of the crankcase system 200 as a function of time. In other words, the signal waveforms of the second pressure 20 and the intake pressure 10 are shown. Both graphs 10, 20 share a common timeline. The second pressure 20 is inverted. In the proper condition, the signal waveforms of the second pressure 20 and the intake pressure 10 are similar, in particular proportional or anti-proportional. In particular, they rise and fall by similar values relative to the respective signal at similar times. This case corresponds to the uppermost signal waveform of the second pressure 20.

However, if a leak occurs in an area 230 of the crankcase downstream of the intake area 210, this produces the two lower signal waveforms for the second pressure 20 (upper signal waveform for a leak of 6 mm, lower signal waveform for a leak of 12 mm). The signal waveform for the intake pressure 10 remains essentially the same. As a result, the similarity of the signal waveforms of the intake pressure 10 and the second pressure 20 decreases in the event of a leak.

Furthermore, in a method 100 according to the invention, it is conceivable that the calculation 130 comprises at least a calculation 130 of a linear function, the course of which essentially corresponds to the signal waveform of the intake pressure 10 and the signal waveform of the second pressure 20 or includes a regression analysis. A linear function is shown in FIG. 2 as an example for the signal waveforms 10, 20 at the point where the pressure increases. The determination of a linear function offers the advantage that a similarity of the signal waveforms can be determined easily and quickly from the linear function, especially by means of a correlation. In a regression analysis, a variety of statistical methods 100 can be selected to determine similarity. The advantage of the regression analysis is that a statistical method tailored to the specific application can be chosen, which can select the best compromise between speed of execution and accuracy of analysis.

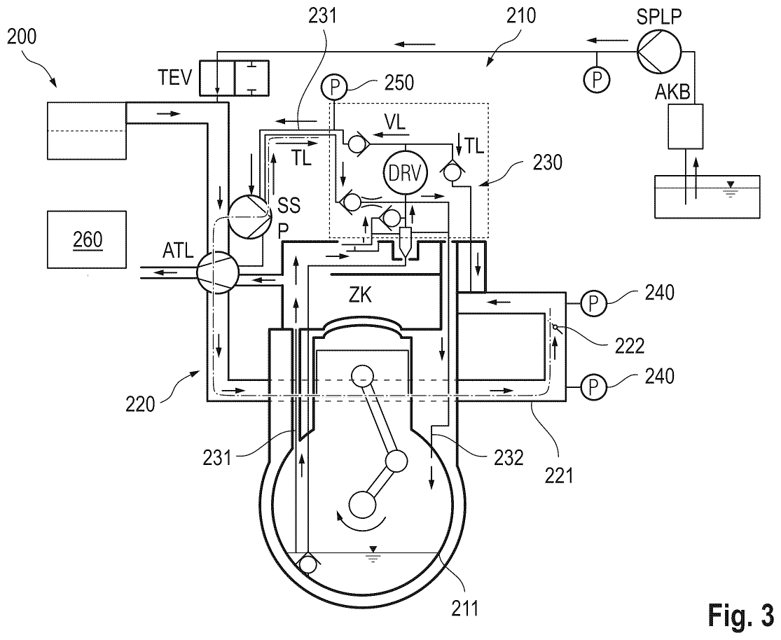

FIG. 3 shows three graphs for the different conditions of the crankcase system 200, which represent the correlation coefficient between the signal waveform of the intake pressure 10 and the signal waveform of the second pressure 20 as a function of time. A Worldwide Harmonized Light Vehicles Test Procedure (WLTP) was measured when the values were recorded. In the left of the three graphs in FIG. 3, the correlation coefficient is close to −1, which corresponds to the proper condition. For a leak of 6 mm (middle graph of FIG. 3), the correlation coefficient deviates from −1. With an even larger leak of 12 mm (right graph of FIG. 3), the correlation coefficient fluctuates around 0. In other words, the correlation coefficient of the signal waveforms of the intake pressure 10 and the second pressure 20 decreases in the event of a leak.

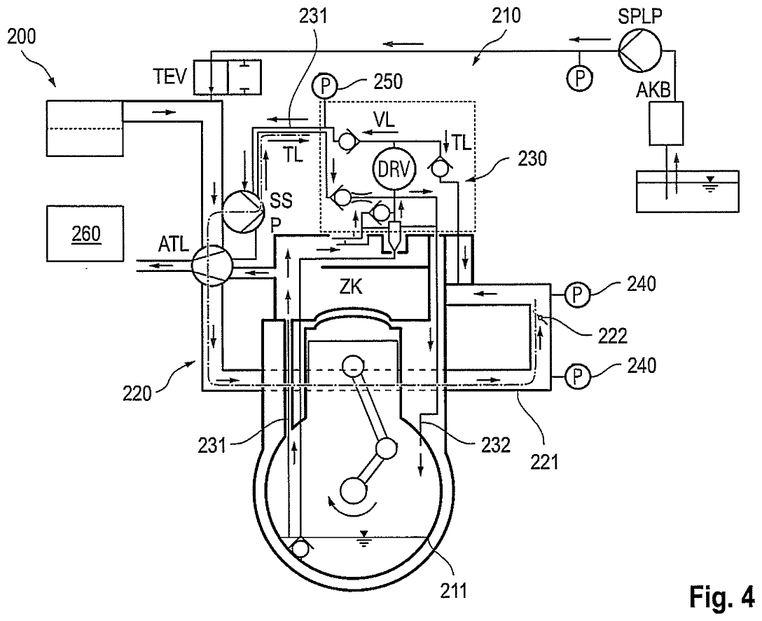

Finally, FIG. 4 shows a crankcase system 200 according to the invention. As shown, the crankcase system 200 has an intake pressure sensor 240 which is designed to determine 110 a signal waveform of an intake pressure 10 in an intake area 220 of a crankcase 210. In addition, the crankcase system 200 has a second pressure sensor 250 which is designed to determine 120 a signal waveform of a second pressure 20 in an area 230 of the crankcase 210 downstream of the intake area. Likewise, the crankcase system 200 has a processor 260, which is designed to calculate 130 a similarity between the signal waveform of the intake pressure 10 and the signal waveform of the second pressure 20 and to compare 140 the similarity with a similarity setpoint range. The processor 260 can be signal-connected to at least the intake pressure sensor 240 and/or the second pressure sensor 250 to receive the readings. A deviation in similarity from the similarity setpoint range indicates that the crankcase system 200 is in an improper condition.

In the context of the invention, it is also conceivable that the determination 110 of the signal waveform of the intake pressure 10 in the intake area 220 as a determination 110 of the signal waveform of the intake pressure 10 is carried out at least in an intake manifold 221 downstream of a throttle 222 or upstream of the throttle 222. By determining the intake pressure 10 in the intake manifold 221 downstream of a throttle 222, the advantage can be achieved that a slightly reduced pressure as compared to the ambient pressure can be measured. In a measurement upstream of the throttle 222, either an ambient pressure or a pressure is applied, which is slightly increased by an exhaust gas turbocharger as compared to the pressure downstream of the throttle 222. It may also be provided that the intake pressure 10 is the average value of measurements downstream of the throttle 222 and upstream of the throttle 222. As a result, measurement errors of a single sensor can be mitigated.

It may also be provided that a plausibility analysis is carried out on the basis of pressure measurements downstream of the throttle 222 and upstream of the throttle 222. This has the advantage that a defective pressure sensor can be detected.

In the context of the invention, it is also conceivable that determining 120 the signal waveform of the second pressure 20 in the area 230 downstream of the intake area is configured as determining 120 the signal waveform of the second pressure 20 at least in a bleed line 231 of the crankcase 210, in a crankcase block 211 or in a ventilation line 232 of the crankcase 210. Measuring the second pressure 20 can be advantageous depending on the operating mode of the combustion engine. Furthermore, the combination of several measurements can be used to carry out a plausibility analysis in order to check the functionality of the pressure sensors. Average values can also be calculated to reduce the impact of individual outliers on the similarity calculation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for diagnosing a crankcase system, the method comprising:
determining of a signal waveform of an intake pressure in an intake area of a crankcase;
determining a signal waveform of a second pressure in an area of the crankcase downstream of the intake area;
calculating a similarity between the signal waveform of the intake pressure and the signal waveform of the second pressure; and
comparing the similarity to a similarity setpoint range,
wherein a deviation of the similarity from the similarity setpoint range indicates an improper condition of the crankcase system.

2. The method according to claim 1, wherein the calculation comprises at least a calculation of a correlation or the calculation of a covariance//linear regression between the signal waveform of the intake pressure and the signal waveform of the second pressure.

3. The method according to claim 1, wherein the calculation comprises at least one calculation of a linear function whose curve essentially corresponds to the signal waveform of the intake pressure and the signal waveform of the second pressure or comprises carrying out a regression analysis.

4. The method according to claim 1, wherein the determination of the signal waveform of the intake pressure in the intake area is carried out as a determination of the signal waveform of the intake pressure in at least one intake manifold downstream of a throttle or upstream of the throttle.

5. The method according to claim 1, wherein the determination of the signal waveform of the second pressure in the area located downstream of the intake area is carried out as determination of the signal waveform of the second pressure at least in a bleed line of the crankcase, in a crankcase block of the crankcase or in a ventilation line of the crankcase.

6. The method according to claim 1, wherein at least the calculation of the similarity takes place when a calculation condition is fulfilled at least for the intake pressure or the second pressure, or the signal waveform of at least the intake pressure or the second pressure comprises only values for which a recording condition is fulfilled.

7. A crankcase system comprising:
an intake pressure sensor configured to determine a signal waveform of an intake pressure in an intake area of a crankcase;
a second pressure sensor to determine a signal waveform of a second pressure in an area of the crankcase downstream of the intake area; and
a processor to calculate a similarity between the signal waveform of the intake pressure and the signal waveform of the second pressure and to compare the similarity with a similarity setpoint range,
wherein a deviation of the similarity from the similarity setpoint range indicates an improper condition of the crankcase system.

8. The crankcase system according to claim 7, wherein the crankcase system is designed to carry out a method comprising:
determining of a signal waveform of an intake pressure in an intake area of the crankcase;
determining the signal waveform of a second pressure in an area of the crankcase downstream of the intake area;
calculating a similarity between the signal waveform of the intake pressure and the signal waveform of the second pressure; and
comparing the similarity to a similarity setpoint range,
wherein a deviation of the similarity from the similarity setpoint range indicates an improper condition of the crankcase system.

9. A vehicle comprising at least one crankcase system according to claim 7.

10. A computer program product, containing commands which, when the program is executed by a computer, in particular a processor of a crankcase system, cause it to execute the method according to claim 1.
